(19) United States
(12) Patent Application Publication
(10) Pub. No.: US 2015/0277696 A1
(43) Pub. Date: Oct. 1, 2015

(54) CONTENT PLACEMENT BASED ON USER INPUT

(71) Applicant: International Business Machines Corporation, Armonk, NY (US)

(72) Inventors: Lisa Seacat DeLuca, Baltimore, MD (US); Lydia M. Do, Raleigh, NC (US); Charles M. Kinard, Cary, NC (US)

(73) Assignee: International Business Machines Corporation, Armonk, NY (US)

(21) Appl. No.: 14/227,162

(22) Filed: Mar. 27, 2014

(51) Int. Cl. G06F 3/0488; G06F 3/0484

(52) U.S. Cl. CPC G06F 3/0488; G06F 3/04842

(57) ABSTRACT

In a method for displaying content corresponding to a character, symbol or shape drawn by a user on a touch screen. In response to the user drawing the character, symbol or shape on the touch screen, a processor determines (a) a size of the character, symbol or shape based on one or more geometric measurements made by the processor of the character, symbol or shape, and (b) content corresponding to the character, symbol or shape. The processor displays on the touch screen the content with a size based in part on the size of the character, symbol or shape drawn by the user.

### TECHNICAL FIELD

The present invention relates generally to user input on a computing device, and more specifically to placing content on a display of a computing device based on a user input on the computing device.

### BACKGROUND

Computing devices such as smart phones, tablet computers, satellite navigation systems, and interactive displays are becoming more prevalent. Comprehensive applications are being created to utilize the capabilities of these computing devices. These computing devices typically include a touch screen or other means that allows for interaction between a user and the device.

Touch screens allow a user to make selections or move a cursor by touching the touch screen via a finger or stylus. In general, touch screens can recognize the size, shape and position of the touch and output this information to a host device. The host device may be a handheld computer, tablet computer, or smart phone. Some touch screens recognize single touches, while others can recognize multiple, simultaneous touches. Some interactive displays do not have a touch screen but operate using an electronic pen that detects light from the pixel on the screen and realizes the position where it points. The electronic pen then emits a radio frequency signal to an electronic pen adapter on a personal computer or other computing device. It is known to recognize a roughly drawn shape on a touch screen and to substitute a perfectly drawn shape for the roughly drawn shape that was recognized.

Touch screens typically include a touch panel, a display screen, and a controller. The touch panel is a clear panel with a touch sensitive surface. The touch panel is positioned in front of the display screen so that the touch sensitive surface covers the viewable area of the display screen. The touch panel registers touches and sends these signals to the controller. The controller processes these signals into data and sends the data to the host device. Any device that houses a touch screen generally provides an Application Programming Interface (API) that programs can call to utilize the data.

A Dolphin™ (Trademark of MoboTap, Inc.) web browser was previously known. With the Dolphin web browser, a user may register a character, symbol or shape as corresponding to a specified Uniform Resource Locator (URL), and subsequently, when the user draws the character, symbol or shape on a touchscreen, the computer substitutes a web page addressed by the URL.

### SUMMARY

Aspects of an embodiment of the present invention disclose a method, system, and a program product for displaying content corresponding to a character, symbol or shape drawn by a user on a touch screen. The method includes, in response to the user drawing the character, symbol or shape on the touch screen, a processor determining (a) a size of the character, symbol or shape based on one or more geometric measurements made by the processor of the character, symbol or shape, and (b) content corresponding to the character, symbol or shape. The method further includes displaying on the touch screen the content with a size based in part on the size of the character, symbol or shape drawn by the user.

Other aspects of an embodiment of the present invention disclose a method, system, and a program product for displaying content corresponding to a character, symbol or shape drawn by a user on a touch screen. The computer program product includes one or more computer readable storage devices and program instructions stored on at least one of the one or more storage devices. The program instructions include program instructions, responsive to a user drawing a character, symbol or shape on a touchscreen, to determine (a) a location of the character, symbol or shape on the touchscreen based on one or more locations on the touchscreen of respective points of the character, symbol or shape, and (b) content corresponding to the character, symbol or shape. The program instructions further include program instructions to display on the touch screen the content at the location of the character, symbol or shape drawn by the user, in place of the character, symbol or shape drawn by the user.

### BRIEF DESCRIPTION OF THE SEVERAL VIEWS OF THE DRAWINGS

FIG. 1 depicts a diagram of a computing device in accordance with one embodiment of the present invention.

FIG. 2 depicts a flowchart of the steps a user input interpretation program executing on the computing device of FIG. 1, for determining content associated with a user input on a touch screen and causing the display of the associated content in place of the user input, in accordance with one embodiment of the present invention.

FIG. 3 depicts a flowchart of the steps of a shape registration program executing on the computing device of FIG. 1, for associating content with a user input, in accordance with one embodiment of the present invention.

FIGS. 4A and 4B are exemplary user interfaces to the computing device of FIG. 1, running the user input interpretation program executing on the computing device of FIG. 1, in accordance with one embodiment of the present invention.

FIG. 5 is a block diagram of components utilized by the computing device of FIG. 1 in accordance with one embodiment of the present invention

### DETAILED DESCRIPTION

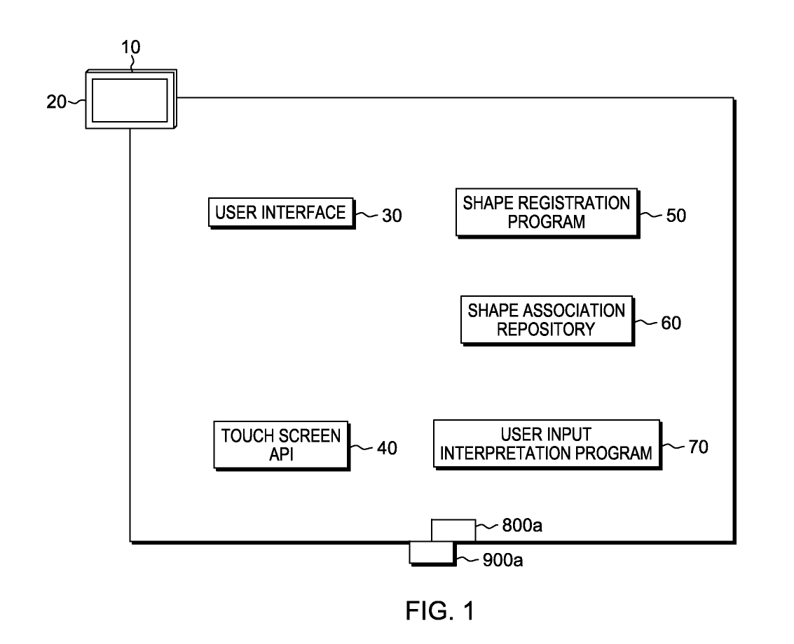

The present invention will now be described in detail with reference to the figures. FIG. 1 depicts a diagram of a computing device 10 in accordance with one embodiment of the present invention. FIG. 1 provides only an illustration of one embodiment and does not imply any limitations with regard to the environments in which different embodiments may be implemented.

Computing device 10 may be a laptop computer, tablet computer, desktop computer, personal digital assistant (PDA), smart phone, or another touch screen device. In general, computing device 10 may be any electronic device or computing system capable of displaying an image on a display screen, accepting user input on a touch screen, and executing computer readable program instructions. Computing device 10 includes touch screen 20, user interface 30, touch screen API 40, shape registration program 50, shape association repository 60, user input interpretation program 70, internal components 800a, and external components 900a.

In one embodiment, touch screen 20 is integrated with computing device 10. Touch screen 20 is configured to receive input from a user's touch and to send this input to computing device 10. Generally, the user input on touch screen 20 can be accessed by a program calling an API, touch screen API 40, provided with computing device 10.

In another embodiment, touch screen 20 may be a separate component (peripheral device) attached to and in communication with computing device 10. In yet another embodiment, touch screen 20 may be an interactive display that operates using an electronic pen that detects light from the pixel on the display screen to detect input from a user on the display screen. The electronic pen then emits a radio frequency signal to an electronic pen adapter on computing device 10. The interactive display may be configured to send the detected user input to computing device 10. Generally, the user input on the interactive display can be accessed by a program calling an API, such as touch screen API 40 configured for an interactive display, provided with computing device 10.

User interface 30 operates on computing device 10 and works in conjunction with touch screen 20 to visualize content, such as icons and application material, and allows a user to interact with computing device 10. User interface 30 may comprise one or more interfaces such as, an operating system interface and application interfaces. User interface 30 receives the user input on touch screen 20 from touch screen API 40 and reports the user input to user input interpretation program 70 or shape registration program 50.

Shape registration program 50 operates on computing device 10 to associate content with a user input for use with user input interpretation program 70. In one embodiment, a mapping is created between the user input and content. Content may be a picture, video, web page, executable file, or any other type of digital content. During the registration process, shape registration program 50 receives from a user a specific user input to associate content with. For example, the user can choose to associate content with the user input of drawing the shape of a heart on touch screen 20. After the user makes the desired user input on touch screen 20, shape registration program 50 receives an indication, from the user, of the content to be associated with the user input. The indication may be a link (e.g., uniform resource locator (URL)) to the content, a file path where the content is located, the content itself, or any other indication of the content.

There are any number of possible user inputs depending on the capabilities of user interface 30 or the underlying application being interacted with through user interface 30. For example, a user may draw an alphanumeric character, graphical symbol or other graphical shape on the touch screen, such as the shape of a heart on touch screen 20. In other examples, the user input may be the drawing of a circle on touch screen 20 or the drawing of any other shape.

In some embodiments, if the capabilities of user interface 30 or the underlying application being interacted with through user interface 30 allow, the user input may be the drawing of a shape where the shape has specific properties as drawn and displayed. For example, some user interfaces allow a user to choose the properties of the shape to be shown as drawn and displayed. In another example, if the user interface is a user interface to an interactive display that operates using an electronic pen, there may be multiple electronic pens each corresponding to a different color. If a user uses a particular pen to draw a shape the shape will be displayed as drawn with an outline shown in the color corresponding to the pen used.

Some examples of specific properties are, but not limited to: width of the outline of the shape; color of the outline of the shape; design of the outline (e.g., a double line, dashed line, dotted line, etc.); size of the shape; location of the shape; fill of the shape (e.g., solid, an X drawn in the middle, etc.); or any other property. One or any combination of properties may be used as part of the user input to associate content with. For example, a user input may be drawing the shape of a heart on touch screen 20 where the heart has a red outline as drawn. In another example, a user input may be drawing the shape of a heart on touch screen 20 where the heart has a red dashed outline as drawn.

After the user makes the desired input on touch screen 20 and indicates the content to be associated with the user input, data describing the user input on touch screen 20 and the indication of the associated content are then stored for use with user input interpretation program 70. In one embodiment, a mapping of data describing the user input on touch screen 20 and the indication of the associated content are stored in shape association repository 60.

In one embodiment, the data describing a user input may be data received from user interface 30 after touch screen 20 detects the user input. For example, data received from user interface 30 may be an indication of what the user input represents. The data received may also include the location of the user input, the size of the user input, or any other information that may be determined by the touch screen. Known touch screens or programs have the capability to process a user input and determine what the user input represents. Multi-touch devices can interpret many user inputs and send an indication of the interpretation to a computing device. In this example, if the user input is drawing the shape of a circle on touch screen 20, touch screen 20 will interpret the user input and send an indication to computing device 10 (e.g., user interface 30) that a circle was drawn on the touch screen. The indication may also include the location of where the circle was drawn and the size of the circle.

In another example, the data received from user interface 30 may be raw data describing the user input. The raw data may be a set of locations of touches on touch screen 20 that make up the user input on the touch screen plane of the touch screen. The touch screen plane is typically mapped into a coordinate system, such as a Cartesian coordinate system, a Polar coordinate system, or some other coordinate system. When a Cartesian coordinate system is used, the touch screen input location corresponds to x and y coordinates. When a Polar coordinate system is used, the touch screen input location corresponds to radial (r) and angular coordinates (A). In this example, shape registration program 50 and user input interpretation program 70 would have the capability to decipher the raw data received from user interface 30.

In another embodiment, the data describing a user input may be data received from user interface 30 after touch screen 20 detects the user input and data received from user interface 30 describing specific properties of the user input as drawn and displayed. For example, data received from user interface 30 may be an indication that a circle was drawn and may describe that the circle was drawn and is displayed with a red outline.

Shape association repository 60 operates to store the mapping of data describing a user input on touch screen 20 and the indication of the content associated with the user input. In one embodiment, shape association repository 60 is a repository that may be written and read by shape registration program 50 and read by user input interpretation program 70. In other embodiments, shape association repository 60 may be a file or a database. In one embodiment, shape association repository 60 resides on computing device 10. In other embodiments, shape association repository 60 may reside on computing device provided that shape association repository 60 is accessible to shape registration program 50 and user input interpretation program 70.

User input interpretation program 70 operates on computing system 10 to determine content associated with a user input on touch screen 20 and to cause the display of the associated content in place of the user input in user interface 30. In one embodiment, user input interpretation program 70 receives data describing a user input on touch screen 20 and determines content associated with the received data. User input interpretation program 70 causes the display of the content associated with the received data. In another embodiment, user input interpretation program 70 receives data describing a user input on touch screen 20 and determines that no content has been associated with the received data. User input interpretation program 70 prompts the user to indicate content to be displayed. The content indicated may be associated with the data describing the user input on touch screen 20 and stored as a mapping in shape association repository 60 for future use.

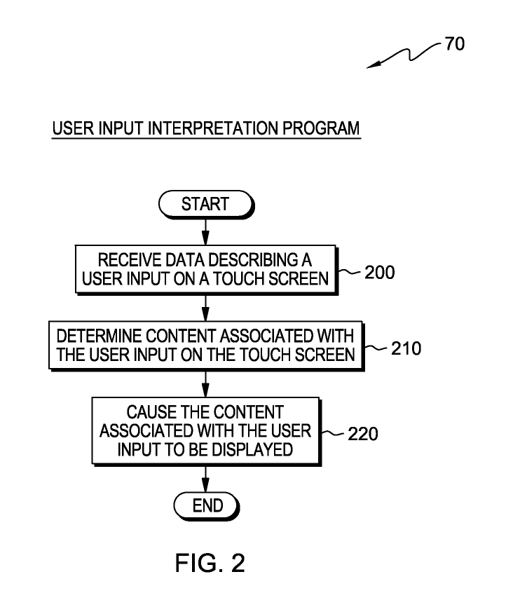

FIG. 2 depicts a flowchart of the steps user input interpretation program 70 executing on computing device 10 of FIG. 1, for determining content associated with a user input on touch screen 20 and causing the display of the associated content in place of the user input, in accordance with one embodiment of the present invention.

Initially, user input interpretation program 70 is initiated. In one embodiment, user input interpretation program 70 is initiated automatically at startup of computing device 10. In another embodiment, user input interpretation program 70 is initiated by a user at computing device 10. The user at computing device 10 makes a user input on touch screen 20.

In step 200, user input interpretation program 70 receives, from user interface 30, data describing the user input on touch screen 20. In one embodiment, the data describing a user input may be data received from user interface 30 after touch screen 20 detects the user input. For example, data received from user interface 30 may be an indication of what the user input represents. The data received may also include the location of the user input, the size of the user input, or any other information that may be determined by the touch screen. In another example, the data received from user interface 30 may be raw data describing the user input. The raw data may be a set of locations of touches on touch screen 20 that make up the user input on the touch screen plane of the touch screen. In this example, shape registration program 50 and user input interpretation program 70 would have the capability to decipher the raw data received from user interface 30. In another embodiment, the data describing a user input may be data received from user interface 30 after touch screen 20 detects the user input and data received from user interface 30 describing specific properties of the user input as drawn and displayed. For example, data received from user interface 30 may be an indication that a circle was drawn and may describe that the circle was drawn and is displayed with a red outline.

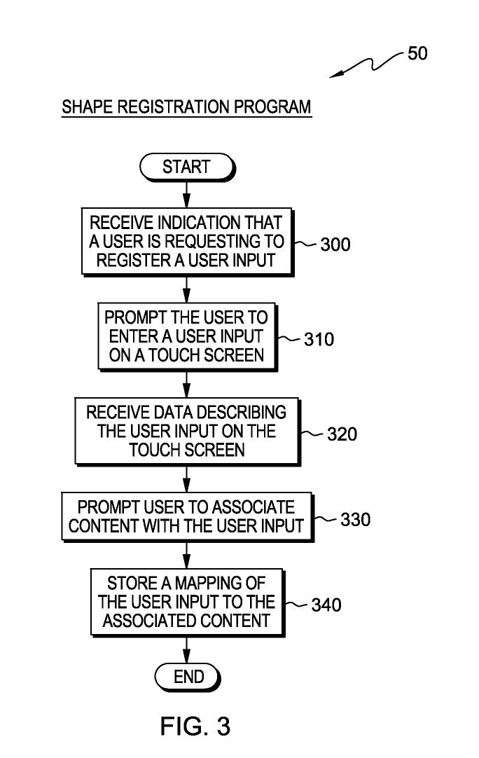

In response to receiving the data describing the user input on touch screen 20, user input interpretation program 70 determines content associated with the user input on touch screen 20 (step 210). In one embodiment, user input interpretation program 70 queries shape association repository 60 to determine content associated with data corresponding to the user input on touch screen 20. For example, user input interpretation program 70 may search mappings stored in shape association repository for stored data corresponding to a user input that matches the received data corresponding to the user input on touch screen 20. The matching may be within a specific error tolerance. The specific error tolerance can be determined by multiple samples of the user input on touch screen 20 during multiple iterations of the registration process, discussed in FIG. 3. The multiple samples set a range of acceptable shapes. The user input on touch screen 20 would have to be within this acceptable range. Any other method of determining a specific error tolerance may be used.

In another embodiment, if user input interpretation program 70 determines that no content has been associated with the user input on touch screen 20, user input interpretation program 70 prompts the user to indicate content to be displayed. For example, user input interpretation program 70 sends, to user interface 30, a prompt for the user to associate content with the user input. User interface 30 sends the prompt to touch screen 20 to be displayed. The prompt may be an entry field where the user may indicate a URL, a file path, or other indication of the content to be associated with the user input. The content indicated may be associated with the data describing the user input on touch screen 20 and stored as a mapping in shape association repository 60 for future use.

In step 220, user input interpretation program 70 causes the content associated with the user input on touch screen 20 to be displayed. In one embodiment, user input interpretation program 70 queries shape association repository 60 for the indication of the content associated with the user input on touch screen 20. User input interpretation program 70 causes the content associated with the user input on touch screen 20 to be displayed using the indication of the content associated with the user input. In one example, if the indication of the content associated with the user input on touch screen 20 is a URL, user input interpretation program 70 sends a command (interrupt) to the operating system of computing device 10. In response to receiving the command (interrupt), the operating system causes a web browser to open to the URL and be displayed in user interface 30 on touch screen 20. In another example, if the indication of the content associated with the user input on touch screen 20 is a file path to the content, user input interpretation program 70 sends a command (interrupt) to the operating system of computing device 10. In response to receiving the command (interrupt), the operating system causes a program (a specific program to view the type of content) to open to view the content and be displayed in user interface 30 on touch screen 20.

In other embodiments, user input interpretation program 70 causes the content associated with the user input on touch screen 20 to be displayed in certain ways based on display parameters. Display parameters may be chosen by a user selecting a display parameters function of user input interpretation program 70 in user interface 30. A user may set display parameters that would apply to all user inputs on touch screen 20 or to a specific user input individually. The display parameters function of user input interpretation program 70 may store the display parameters along with the mapping of the user input to the associated content in shape association repository 60.

Any instructions to display the content may be sent from user input interpretation program 70 to a window manager of user interface 30. A window manager is system software that controls the placement and appearance of windows within a windowing system in a graphical user interface. Most window managers work in conjunction with the underlying graphical system that provides required functionality. Most graphical user interfaces based on a windows metaphor has some form of window management. In practice, the elements of this functionality vary greatly. Elements usually associated with window managers allow the user to open, close, minimize, maximize, move, resize, and keep track of running windows, including window decorators.

Some examples of display parameters are, but not limited to: location of the displayed content; zoom of the displayed content; or size of the displayed content. For each display parameter there may be a default parameter or the user may customize the parameters. In embodiment, as a default the content associated with the user input on touch screen 20 will be displayed at the same location as the user input was made on touch screen 20. The user may choose to have the content associated with the user input on touch screen 20 to always be displayed in the upper left corner of touch screen 20 no matter what location the user input was made on touch screen 20. In another embodiment, as a default the content associated with the user input on touch screen 20 will be displayed with a size that corresponds to the size of the user input on touch screen 20. For example, if the user input is a box and the content associated with the user input is a picture of a laptop, the picture of the laptop will be displayed with a size approximately to the outline of the box. In yet another embodiment, as a default the zoom of the displayed content would be such that the content would completely fit within the outline of the user input on touch screen 20.

In other embodiments, a series of inputs on touch screen 20 may be considered a singular user input on touch screen 20 for the purposes of steps 200 through 220 of FIG. 2. Each input of the series of inputs on touch screen 20 may be associated with completing a step of user input interpretation program 70. A first input of the series of inputs may indicate the where the content associated with the user input on touch screen 20 is to be displayed in user interface 30 (e.g., step 220). The content associated with the user input on touch screen 20 may be mapped to a second input of the series of inputs or the content may be mapped with the first input and the second input of the series of inputs (e.g., step 210). For example, if a user inputs a square on touch screen 20 then inputs a circle inside of the square on touch screen 20, the location of the square on touch screen 20 will be the location the content associated with the circle will be displayed in user interface 30. In another example, if a user inputs a square on touch screen 20 then inputs a circle inside of the square on touch screen 20, the location of the square on touch screen 20 will be the location the content associated with the square drawn followed by the circle will be displayed in user interface 30.

FIG. 3 depicts a flowchart of the steps of shape registration program 50 executing on computing device 10 of FIG. 1, for associating content with a user input, in accordance with one embodiment of the present invention.

In step 300, shape registration program 50 receives, from user interface 30, an indication that a user is requesting to register a user input. In one embodiment, step 300 involves the user selecting a shape registration function of user input interpretation program 70 in user interface 30, upon which the user interface sends the indication to shape registration program 50.

In response to receiving the indication of the shape registration request, shape registration program 50 prompts the user to enter a user input on touch screen 20 (step 310). In one embodiment, shape registration program 50 sends, to user interface 30, a prompt requesting the user to enter a user input on touch screen 20. User interface 30 displays on touch screen 20 a prompt requesting the user to enter a user input. In some embodiments, if the capabilities of user interface 30 or the underlying application being interacted with through user interface 30 allow, the user may choose specific properties for the user input to have as drawn and displayed before making the user input. For example, the user may choose that the user input will have a red outline when drawn and displayed. These options are accessible through the capabilities of user interface 30 or the underlying program.

Shape registration program 50 receives, from user interface 30, data describing the user input on touch screen 20 (step 320). The user makes a user input on touch screen 20. User interface 30 receives the user input on touch screen 20 from touch screen API 40 and reports the user input to shape registration program 50.

In one embodiment, the data describing the user input may be data received from user interface 30 after touch screen 20 detects the user input. For example, data received from user interface 30 may be an indication of what the user input represents. The data received may also include the location of the user input, the size of the user input, or any other information that may be determined by the touch screen. In another embodiment, the data describing the user input may be data received from user interface 30 after touch screen 20 detects the user input and data received from user interface 30 describing specific properties of the user input as drawn and displayed. For example, data received from user interface 30 may be an indication that a circle was drawn and may describe that the circle was drawn and displayed with a red outline.

In response to receiving the data describing the user input on touch screen 20, shape registration program 50 sends, to user interface 30, a prompt for the user to associate content with the user input (step 330). In one embodiment, the prompt may be a request for the user to provide an indication of the content to be associated with the user input. For example, the prompt may be an entry field where the user may indicate a URL, a file path, or other indication of the content to be associated with the user input.

In step 340, shape registration program 50 stores a mapping of the user input to the associated content in shape association repository 60. In one embodiment, a mapping of the data describing the user input on touch screen 20 and the indication of the associated content are stored for use by user input interpretation program 70 in shape association repository 60. User input interpretation program 70 may access the stored mappings when carrying out step 210 of FIG. 2.

In other embodiments, a user may associate content with a series of inputs on touch screen 20. The series of inputs may be considered a singular user input on touch screen 20. The user may also associate content with just one input of the series of inputs on touch screen 20. The other inputs in the series may be used to denote certain display parameters for the content.

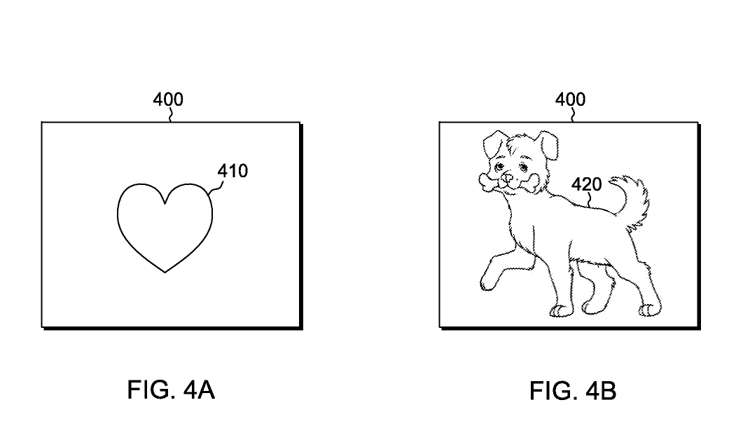

FIGS. 4A and 4B are exemplary user interfaces to computing device 10 of FIG. 1 running user input interpretation program 70 on computing device 10 of FIG. 1, in accordance with one embodiment of the present invention.

In FIG. 4A, user interface 400 is a user interface displayed on a touch screen displaying user input 410. A user makes user input 410 on the touch screen displaying user interface 400. Given that user input 410 is a heart, user input interpretation program 70 determines content that is associated with a heart. In this example, data describing user input 410 is an indication of what user input 410 represents (e.g., a heart) as determined by the touch screen. User input interpretation program 70 determines content that is associated with user input 410 (e.g., a heart). Because content 420 is associated with user input 410, in FIG. 4B, content 420 is displayed in user interface 400. User input interpretation program 70, causes content 420 to be displayed in place of user input 410 in user interface 400.

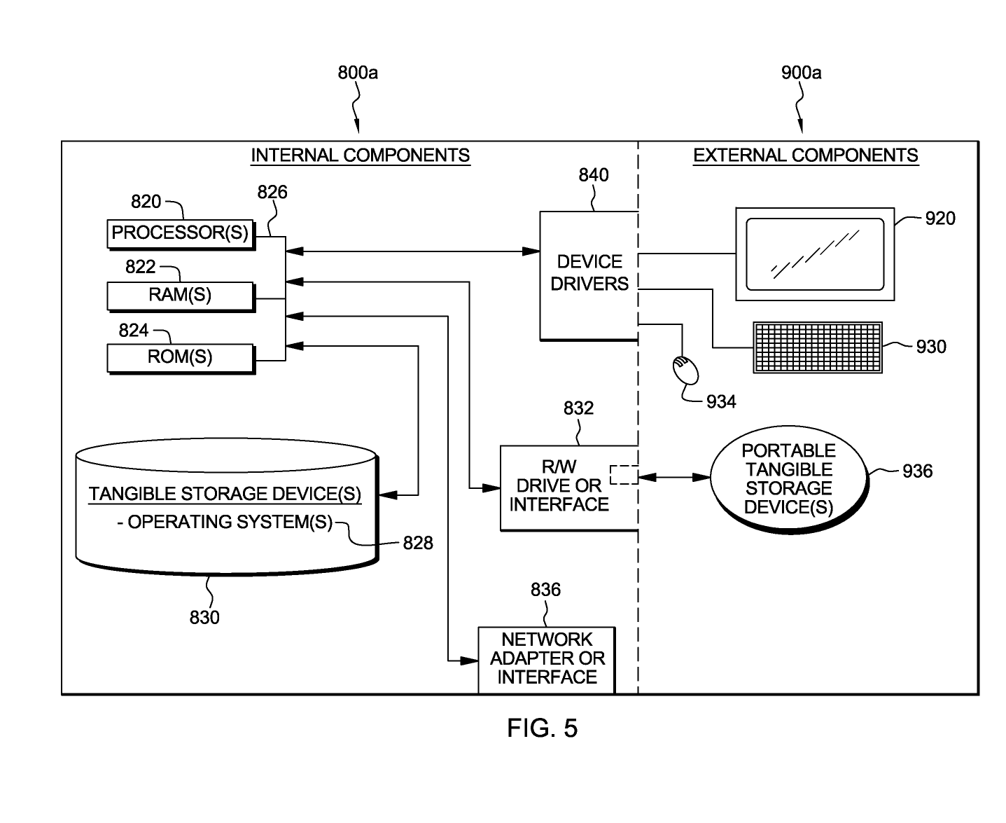

FIG. 5 is a block diagram of components utilized by computing device 10 of FIG. 1 in accordance with one embodiment of the present invention.

Computing device 10 includes internal components 800a and external components 900a, illustrated in FIG. 5. Internal components 800a includes one or more processors 820, one or more computer readable RAMs 822 and one or more computer readable ROMs 824 on one or more buses 826, one or more operating systems 828 and one or more computer readable storage devices 830. Computer readable storage device is a computer readable storage medium as defined below. The one or more operating systems 828 and user interface 30, touch screen API 40, shape registration program 50, shape association repository 60, and user input interpretation program 70 are stored on one or more of the respective computer readable storage devices 830 for execution and/or access by one or more of the respective processors 820 via one or more of the respective RAMs 822 (which typically include cache memory). In the illustrated embodiment, each of the computer readable storage devices 830 is a magnetic disk storage device of an internal hard drive. Alternatively, each of the computer readable storage devices 830 is a semiconductor storage device such as ROM 824, EPROM, flash memory or any other computer readable storage device that can store but does not transmit a computer program and digital information.

Internal components 800a also includes a R/W drive or interface 832 to read from and write to one or more portable computer readable storage devices 936 that can store but do not transmit a computer program, such as a CD-ROM, DVD, memory stick, magnetic tape, magnetic disk, optical disk or semiconductor storage device. User interface 30, touch screen API 40, shape registration program 50, shape association repository 60, and user input interpretation program 70 can be stored on one or more of the respective portable computer readable storage devices 936, read via the respective R/W drive or interface 832 and loaded into the respective hard drive or semiconductor storage device 830. The term “computer readable storage device” does not encompass signal propagation media such as copper cables, optical fibers and wireless transmission media.

Internal components 800a also includes a network adapter or interface 836 such as a TCP/IP adapter card or wireless communication adapter (such as a 4G wireless communication adapter using OFDMA technology). User interface 30, touch screen API 40, shape registration program 50, shape association repository 60, and user input interpretation program 70 can be downloaded to the respective computing/processing devices from an external computer or external storage device via a network (for example, the Internet, a local area network or other, wide area network or wireless network) and network adapter or interface 836. From the network adapter or interface 836, the programs are loaded into the respective hard drive or semiconductor storage device 830. The network may comprise copper wires, optical fibers, wireless transmission, routers, firewalls, switches, gateway computers and/or edge servers.

External components 900a includes a display screen 920, a keyboard or keypad 930, and a computer mouse or touchpad 934. Alternatively, external components 900a may include a touch screen. Internal components 800a also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in storage device 830 and/or ROM 824).

The programs can be written in various programming languages (such as C+) including low-level, high-level, object-oriented or non-object-oriented languages. Alternatively, the functions of the programs can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for displaying content corresponding to a character, symbol or shape drawn by a user on a touch screen, the method comprising the steps of:
in response to the user drawing the character, symbol or shape on the touch screen, a processor determining (a) a size of the character, symbol or shape based on one or more geometric measurements made by the processor of the character, symbol or shape, and (b) content corresponding to the character, symbol or shape; and
displaying on the touch screen the content with a size based in part on the size of the character, symbol or shape drawn by the user.

2. The method of claim 1, wherein the step of the processor determining the content corresponding to the character, symbol or shape drawn by the user comprises the step of:
a processor searching a repository to determine a stored character, symbol or shape that matches the character, symbol or shape drawn by the user within a specific graphical error tolerance.

3. The method of claim 1, wherein the size of the character, symbol or shape drawn by the user input is based on a longest straight line whose ends terminate on the character, symbol or shape.

4. The method of claim 1, wherein the size of the character, symbol or shape drawn by the user input is based on a height and width of the character, symbol or shape.

5. The method of claim 4, wherein a height and width of the displayed content approximates the height and width of the character, symbol or shape drawn by the user.

6. The method of claim 1, further comprising the steps of:
receiving a second character, symbol or shape drawn by the user on the touch screen;
in response to the user drawing the second character, symbol or shape on the touch screen, a processor determining (a) a size of the second character, symbol or shape based on one or more geometric measurements made by the processor of the second character, symbol or shape, and (b) that no content corresponds to the second character, symbol or shape; and
a processor prompting the user to associate a second content with the second character, symbol or shape on the touch screen.

7. The method of claim 6, further comprising the steps of:
a processor receiving an indication of the second content to be associated with the second character, symbol or shape drawn by the user; and
a processor storing a mapping of the second character, symbol or shape drawn by the user to the second content in a repository.

8. A computer program product for displaying content corresponding to a character, symbol or shape drawn by a user on a touch screen, the computer program product comprising:
one or more computer readable storage devices and program instructions stored on at least one of the one or more storage devices, the program instructions comprising:
program instructions, responsive to a user drawing a character, symbol or shape on a touchscreen, to determine (a) a location of the character, symbol or shape on the touchscreen based on one or more locations on the touchscreen of respective points of the character, symbol or shape, and (b) content corresponding to the character, symbol or shape; and
program instructions to display on the touch screen the content at the location of the character, symbol or shape drawn by the user, in place of the character, symbol or shape drawn by the user.

9. The computer program product of claim 8, wherein the program instructions to determine the content corresponding to the character, symbol or shape drawn by the user comprise:
program instructions to search a repository to determine a stored character, symbol or shape that matches the character, symbol or shape drawn by the user within a specific graphical error tolerance.

10. The computer program product of claim 8, wherein the program instructions, responsive to a user drawing a character, symbol or shape on a touchscreen, to determine (a) a location of the character, symbol or shape on the touchscreen based on one or more locations on the touchscreen of respective points of the character, symbol or shape, and (b) content corresponding to the character, symbol or shape comprise:
program instructions, responsive to a user drawing a character, symbol or shape on a touchscreen, to determine (a) a location of the character, symbol or shape on the touchscreen based on one or more locations on the touchscreen of respective points of the character, symbol or shape, (b) content corresponding to the character, symbol or shape, and (c) a size of the character, symbol or shape based on one or more geometric measurements made by the processor of the character, symbol or shape.

11. The computer program product of claim 10, wherein the size of the character, symbol or shape drawn by the user input is based on a longest straight line whose ends terminate on the character, symbol or shape.

12. The computer program product of claim 10, wherein the size of the character, symbol or shape drawn by the user input is based on a height and width of the character, symbol or shape.

13. The computer program product of claim 12, wherein a height and width of the displayed content approximates the height and width of the character, symbol or shape drawn by the user.

14. The computer program product of claim 10, wherein the program instructions to display on the touch screen the content at the location of the character, symbol or shape drawn by the user, in place of the character, symbol or shape drawn by the user comprise:
program instructions to display on the touch screen the content at the location of the character, symbol or shape drawn by the user, in place of the character, symbol or shape drawn by the user and with a size based in part on the size of the character, symbol or shape drawn by the user.

15. A computer program product for displaying content corresponding to a character, symbol or shape drawn by a user on a touch screen, the computer program product comprising:
one or more computer readable storage devices and program instructions stored on at least one of the one or more storage devices, the program instructions comprising:
program instructions, responsive to the user drawing the character, symbol or shape on the touch screen, to determine (a) a size of the character, symbol or shape based on one or more geometric measurements made by the processor of the character, symbol or shape, and (b) content corresponding to the character, symbol or shape; and
program instructions to display on the touch screen the content with a size based in part on the size of the character, symbol or shape drawn by the user.

16. The computer program product of claim 15, wherein the program instructions to determine the content corresponding to the character, symbol or shape drawn by the user comprise:
program instructions to search a repository to determine a stored character, symbol or shape that matches the character, symbol or shape drawn by the user within a specific graphical error tolerance.

17. The computer program product of claim 15, wherein the size of the character, symbol or shape drawn by the user input is based on a longest straight line whose ends terminate on the character, symbol or shape.

18. The computer program product of claim 15, wherein the size of the character, symbol or shape drawn by the user input is based on a height and width of the character, symbol or shape.

19. The computer program product of claim 18, wherein a height and width of the displayed content approximates the height and width of the character, symbol or shape drawn by the user.

20. The computer program product of claim 15, further comprising program instructions, stored on at least one of the one or more storage devices, the program instructions comprising:
program instructions to receive a second character, symbol or shape drawn by the user on the touch screen;
program instructions, responsive to the user drawing the second character, symbol or shape on the touch screen, to determine (a) a size of the second character, symbol or shape based on one or more geometric measurements made by the processor of the second character, symbol or shape, and (b) that no content corresponds to the second character, symbol or shape; and
program instructions to prompt the user to associate a second content with the second character, symbol or shape on the touch screen.
